(19) United States
(12) Patent Application Publication
(10) Pub. No.: US 2009/0050450 A1
(43) Pub. Date: Feb. 26, 2009

(54) COMPUTER DEVICE WITH KEYBOARD LOCK FUNCTION, AND METHOD OF PERFORMING KEYBOARD LOCK IN THE COMPUTER DEVICE

(76) Inventor: Chun-Pin CHENG, Taipei Hsien (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/942,271

(22) Filed: Nov. 19, 2007

(30) Foreign Application Priority Data
Aug. 22, 2007 (TW) 096131078

(51) Int. Cl. H01H 9/28

(52) U.S. Cl. 200/43.01

(57) ABSTRACT

A computer device includes a keyboard connected electrically to a main module. The keyboard is operable between a lock mode, where the keyboard is inhibited from outputting a scan code signal, and an unlock mode, where the keyboard is enabled to output a scan code signal corresponding to a pressed one of keys of the keyboard. When one of the keys of the keyboard is pressed while the keyboard is operated in the lock mode, the keyboard provides a control signal to an input/output interface unit of the main module for controlling generation of an indication output. A method of performing keyboard lock in the computer device is also disclosed.

### CROSS-REFERENCE TO RELATED APPLICATION

This application claims priority of Taiwanese Application No. 096131078, filed on Aug. 22, 2007.

### BACKGROUND OF THE INVENTION

1. Field of the Invention

The invention relates to a computer keyboard, more particularly to a computer device with a keyboard lock function, and a method of performing keyboard lock in the computer device.

2. Description of the Related Art

Referring to FIG. 1, a conventional computer device 9 is shown to include a keyboard 91, an input/output module 93, a central processor 94, and a storage device 95. The keyboard 91 includes a key unit 911 having a plurality of keys, a memory module 913, and a control module 912 connected electrically to the key unit 911 and the memory module 913. The input/output module 93 is connected electrically to the control module 912. The central processor 94 is connected electrically to the input/output module 93 and the storage device 95. The storage device 95 stores an operating system 951 and an application program 952 therein. Upon detection that one of the keys of the key unit 911 is pressed, the control module 912 outputs a scan code signal from the memory module 913 corresponding to said one of the keys to the input/output module 93 for subsequent processing.

In the conventional computer device 9, functions associated with a portion of the keys may be selectively locked and unlocked using predetermined keys, such as Num Lock and Caps Lock.

In a conventional keyboard disclosed in U.S. Pat. No. 5,097,506, it is determined whether all keyboard activity is blocked from a system microprocessor by entering a password sequence, which is inconvenient.

In another conventional keyboard disclosed in U.S. Pat. No. 6,211,475, a slidable key lock switch is operable so as to switch between a lock position and an unlock position. Therefore, a key lock mechanism including the key lock switch is necessary for the conventional keyboard, thereby increasing costs.

### SUMMARY OF THE INVENTION

Therefore, the object of the present invention is to provide a computer device with a keyboard lock function, and a method of performing keyboard lock in the computer device that can overcome the aforesaid drawbacks of the prior art.

According to one aspect of the present invention, there is provided a method of performing keyboard lock in a computer device. The computer device includes a keyboard, a display unit, and a main module connected electrically to the keyboard and the display unit. The method comprises the steps of:

a) setting the keyboard in one of a lock mode, where the keyboard is inhibited from outputting a scan code signal, and an unlock mode, where the keyboard is enabled to output a scan code signal corresponding to a depressed key thereof to the main module; and

b) generating an indication output when the keyboard is operated in the lock mode.

According to another aspect of the present invention, a computer device comprises:

a keyboard including a plurality of keys and operable between a lock mode, where the keyboard is inhibited from outputting a scan code signal, and an unlock mode, where the keyboard is enabled to output a scan code signal corresponding to a pressed one of the keys, the keyboard being capable of being set in a current one of the lock mode and the unlock mode;

a display unit; and

a main module including
an input/output interface unit connected electrically to the keyboard and the display unit,
a storage unit for storing an operating system therein, and
a processing unit connected electrically to the input/output interface unit and the storage unit, and receiving the scan code signal from the keyboard via the input/output interface unit.

When one of the keys of the keyboard is pressed while the keyboard is operated in the lock mode, the keyboard provides a control signal to the input/output interface unit of the main module for controlling generation of an indication output.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a conventional computer device;

FIG. 2 is a perspective view showing the preferred embodiment of a computer device according to the present invention; and

FIG. 3 is a schematic circuit block diagram illustrating the preferred embodiment.

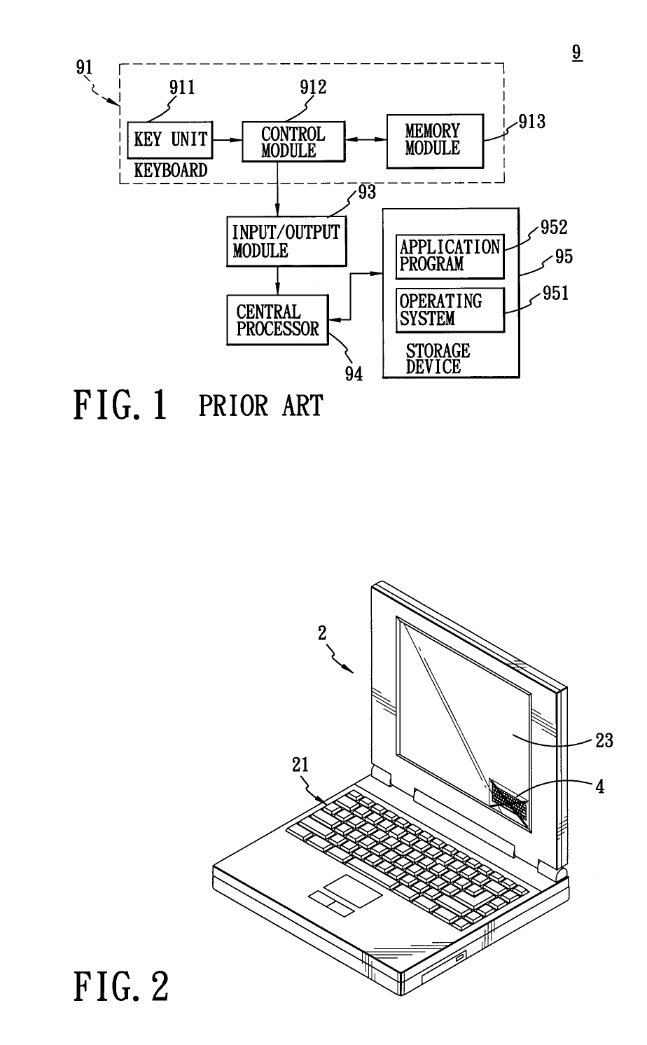

### DETAILED DESCRIPTION OF THE PREFERRED EMBODIMENT

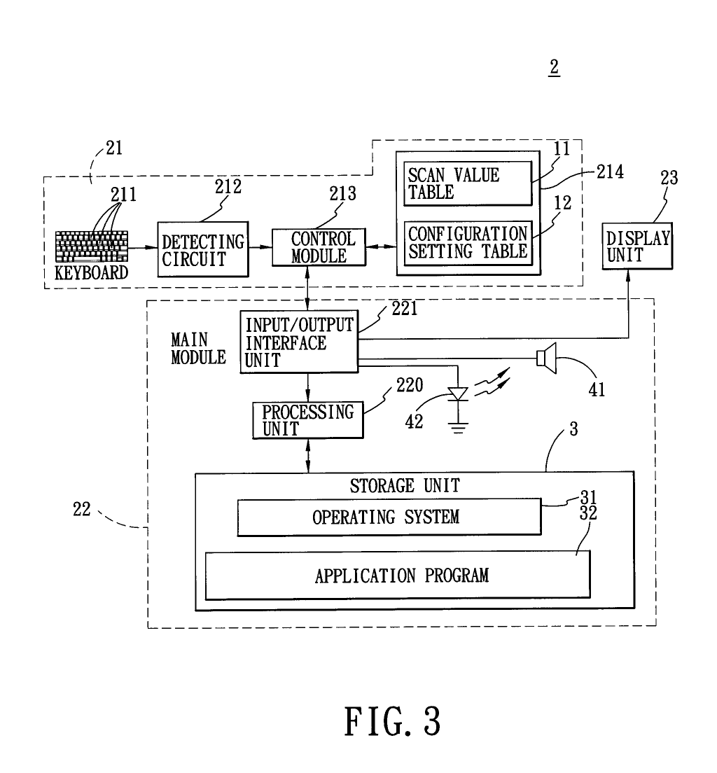

Referring to FIGS. 2 and 3, the preferred embodiment of a computer device 2 according to the present invention is shown to include a keyboard 21, a display unit 23, and a main module 22. In this embodiment, the computer device 2 is a portable computer.

The keyboard 21 includes a plurality of keys 211, and is operable between a lock mode, where the keyboard 21 is inhibited from outputting a scan code signal, and an unlock mode, where the keyboard 21 is enabled to output a scan code signal corresponding to a pressed one of the keys 211. The keyboard 21 is capable of being set in a current one of the lock mode and the unlock mode. The details of the keyboard 21 will be described later.

The main module 22 includes an input/output interface unit 221, a storage unit 3 and a processing unit 220. The input/output interface unit 221 is connected electrically to the keyboard 21 and the display unit 23. The storage unit 3 stores an operating system 31 therein. The processing unit 220 is connected electrically to the input/output interface unit 221 and the storage unit 3, and receives the scan code signal from the keyboard 21 via the input/output interface unit 221.

In this embodiment, the keyboard 21 further includes a detecting circuit 212, a memory unit 214 and a control module 213. The memory unit 214 stores a scan value table 11 that records a plurality of scan values corresponding respectively to the keys 211, and a configuration setting table 12 that records a configuration setting value being one of first and second values corresponding respectively to the lock and unlock modes of the keyboard 21. The detecting circuit 212 detects whether one of the keys 211 is pressed. The control module 213 is connected electrically to the detecting circuit 212, the memory unit 214 and the input/output interface 221 of the main module 22. The control module 213 outputs the scan code signal associated with one of the scan values in the scan value table 11 of the memory unit 214 corresponding to a pressed one of the keys 211 to the input/output interface unit 221 of the main module 22 when the configuration setting value in the configuration setting table 12 of the memory unit 214 is the second value. When one of the keys 211 is pressed while the keyboard 21 is operated in the lock mode, i.e., the configuration setting value in the configuration setting table 12 of the memory unit 214 is the first value, the control module 213 provides a control signal to the input/output interface unit 221 of the main module 22 for controlling generation of an indication output.

In this embodiment, the current one of the lock and unlock modes of the keyboard 21 is set through a preset key input of the keyboard 21 such that the configuration setting value in the configuration setting table 12 of the memory unit 214 is changed by the control module 213 in response to the preset key input. The preset key input is generated by pressing a predetermined one of the keys 211 of the keyboard 21, such as a hot key. Alternatively, the preset key input can be generated by pressing a predetermined combination of the keys 211 of the keyboard 21. However, in other embodiments, the current one of the lock and unlock modes of the keyboard 21 can be set through execution of an application program (not shown), which is stored in the storage unit 3, which is for the operating system 31, and which is associated with control for the keyboard 21, by the processing unit 220 of the main module 22 such that the control module 213 of the keyboard 21 is notified to change the configuration setting value as a result of the execution of the application program by the processing unit 220.

In this embodiment, the storage unit 3 of the main module 22 further stores an application program 32 for the operating system 31 therein. The control signal from the control module 213 of the keyboard 21 is received by the processing unit 220 via the input/output interface unit 221 such that the processing unit 220 of the main module 22 executes the application program 32 stored in the storage unit 3 in response to the control signal. However, in other embodiments, the main module 22 can generate the indication output in response to the control signal received by the input/output interface unit 220 without requirement for the application program 32.

In this embodiment, the indication output is in the form of at least one of a visible output and an audible output, wherein the visible output can be either an image pattern 4 displayed on the display unit 23, as shown in FIG. 2, or light radiated by a lamp 42, such as a light emitting diode, connected electrically to the input/output interface unit 221, whereas the audible output is sound generated by a buzzer 41 connected electrically to the input/output interface unit 221.

In sum, since the current one of the lock and unlock modes of the keyboards 21 can be easily set by pressing the predetermined key of the keyboard 21 without requirement for an additional switch mechanism, the computer device 2 can easily perform keyboard lock as compared to the aforesaid conventional keyboard using input of a password sequence. Furthermore, due to the presence of the indication output, the user can be appropriately informed of the lock mode of the keyboard 21, thereby resulting in convenience during use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of performing keyboard lock in a computer device, the computer device including a keyboard, a display unit, and a main module connected electrically to the keyboard and the display unit, the method comprising the steps of:
a) setting the keyboard in one of a lock mode, where the keyboard is inhibited from outputting a scan code signal, and an unlock mode, where the keyboard is enabled to output a scan code signal corresponding to a depressed key thereof to the main module; and
b) generating an indication output when the keyboard is operated in the lock mode.

2. The method as claimed in claim 1, wherein, in step a), said one of the lock and unlock modes of the keyboard is set through a preset key input of the keyboard.

3. The method as claimed in claim 2, wherein the preset key input is generated by pressing a predetermined key of the keyboard.

4. The method as claimed in claim 2, wherein the preset key input is generated by pressing a predetermined combination of keys of the keyboard.

5. The method as claimed in claim 1, wherein, in step a), said one of the lock and unlock modes of the keyboard is set through execution of an application program for an operating system by the main module.

6. The method as claimed in claim 1, wherein, in step b), the indication output is generated when one of keys of the keyboard is pressed.

7. The method as claimed in claim 1, wherein the indication output is in the form of at least one of a visible output and an audible output.

8. The method as claimed in claim 7, wherein the visible output is an image pattern displayed on the display unit.

9. The method as claimed in claim 7, wherein the visible output is light radiated by a lamp.

10. The method as claimed in claim 9, wherein the lamp is a light emitting diode.

11. The method as claimed in claim 7, wherein the audible output is sound generated by a buzzer.

12. A computer device comprising:
a keyboard including a plurality of keys and operable between a lock mode, where said keyboard is inhibited from outputting a scan code signal, and an unlock mode, where said keyboard is enabled to output a scan code signal corresponding to a pressed one of said keys, said keyboard being capable of being set in a current one of the lock mode and the unlock mode;
a display unit; and
a main module including
an input/output interface unit connected electrically to said keyboard and said display unit,
a storage unit for storing an operating system therein, and
a processing unit connected electrically to said input/output interface unit and said storage unit, and receiving the scan code signal from said keyboard via said input/output interface unit;
wherein, when one of said keys of said keyboard is pressed while said keyboard is operated in the lock mode, said keyboard provides a control signal to said input/output interface unit of said main module for controlling generation of an indication output.

13. The computer device as claimed in claim 12, wherein said keyboard further includes
a memory unit for storing a scan value table that records a plurality of scan values corresponding respectively to said keys, and a configuration setting table that records a configuration setting value being one of first and second values corresponding respectively to the lock and unlock modes of said keyboard,
a detecting circuit for detecting whether one of said keys is pressed, and
a control module connected electrically to said detecting circuit, said memory unit and said input/output interface unit of said main module,
said control module outputting the scan code signal associated with one of the scan values in said scan value table of said memory unit corresponding to a pressed one of said keys to said input/output interface unit of said main module when the configuration setting value in said configuration setting table of said memory unit is the second value,
said control module providing the control signal to said input/output interface unit of said main module when the configuration setting value in said configuration setting table of said memory unit is the first value.

14. The computer device as claimed in claim 13, wherein the current one of the lock and unlock modes of said keyboard is set through a preset key input of said keyboard such that the configuration setting value in said configuration setting table of said memory unit is changed by said control module in response to the preset key input.

15. The computer device as claimed in claim 14, wherein the preset key input is generated by pressing a predetermined one of said keys of said keyboard.

16. The computer device as claimed in claim 14, wherein the preset key input is generated by pressing a predetermined combination of said keys of said keyboard.

17. The computer device as claimed in claim 13, wherein:
said storage unit of said main module further stores an application program for said operating system therein, said application program being associated with control for said keyboard; and
the current one of the lock and unlock modes of said keyboard is set through execution of said application program stored in said storage unit by said processing unit of said main module such that said control module of said keyboard is notified to change the configuration setting value as a result of the execution of said application program by said processing unit.

18. The computer device as claimed in claim 13, wherein said main module generates the indication output in response to the control signal received by said input/output interface unit of said main module.

19. The computer device as claimed in claim 13, wherein:
said storage unit of said main module further stores an application program for said operating system therein; and
the control signal from said control module of said keyboard is received by said processing unit via said input/output interface unit such that said processing unit of said main module executes said application program stored in said storage unit in response to the control signal.

20. The computer device as claimed in claim 18, wherein the indication output is in the form of at least one of a visible output and an audible output.

21. The computer device as claimed in claim 20, wherein the visible output is an image pattern displayed on said display unit.

22. The computer device as claimed in claim 20, wherein:
said main module further includes a lamp connected electrically to said input/output interface unit; and
the visible output is light radiated by said lamp.

23. The computer device as claimed in claim 22, wherein said lamp is a light emitting diode.

24. The computed device as claimed in claim 20, wherein:
said main module further includes a buzzer connected electrically to said input/output interface unit; and
the audible output is sound generated by said buzzer.
